(19) United States
(12) Patent Application Publication
(10) Pub. No.: US 2026/0249810 A1
(43) Pub. Date: Aug. 27, 2026

(54) SYSTEM FOR PROVIDING A SIGNAL FROM A VEHICLE ACCESS DEVICE

(71) Applicant: FCA US LLC, Auburn Hills, MI (US)

(72) Inventors: Thanuj Kumar Komaragunta, Chennai (IN); Dheeraj Batta, Chennai (IN)

(21) Appl. No.: 19/061,209

(22) Filed: Feb. 24, 2025

(51) Int. Cl. B60R 25/24; B60R 25/01

(52) U.S. Cl. CPC B60R 25/24; B60R 25/01

(57) ABSTRACT

A vehicle access device may include a body housing, an input, a conductor, a home contact, and a first contact, wherein the conductor, the home contact, and the first contact are capable of conducting electricity. The input is accessible from outside the body, movable in a first direction towards the conductor from a retracted position to an advanced position, and movable in a second direction, perpendicular to the first direction, between a home position and a first actuating position. When the input is in the advanced position, the conductor is movable with the input between the home position and the first actuating position. When the input is in the retracted position, the input is movable independently from the conductor between the home position and the first actuating position.

### FIELD

The present disclosure relates to a vehicle access device, and a system for providing a signal from the vehicle access device.

### BACKGROUND

Key fobs may use push-activated buttons or touch screens to activate vehicle functions of the vehicle. However, these buttons or touch screens may be accidentally activated by inadvertent contact with a user or another item in handling the key fob. This results in unintended transmission from the key fob and the unintended activation of one or more vehicle functions.

### SUMMARY

In at least some implementations, a vehicle access device includes a body having an interior, an input carried by the body, a conductor received within the interior, a home contact received within the interior, and a first contact received within the interior. The conductor, the home contact, and the first contact are capable of conducting electricity. The input is accessible from outside the body, the input is movable in a first direction from a retracted position to an advanced position, and the input is movable in a second direction, perpendicular to the first direction, between a home position and a first actuating position. The conductor is selectively movable with the input in the second direction between the home position and the first actuating position, wherein in the home position, the conductor is in contact with the home contact but not the first contact, and in the first actuating position the conductor is in contact with both the home contact and the first contact.

In at least some implementations, the input is movable in the first direction relative to the conductor and when the input is in the advanced position, the conductor is movable with the input in the second direction, and when the input is in the retracted position, the input is movable in the second direction independently from the conductor.

In at least some implementations, the input is releasably engageable with the conductor through contact between an input coupling portion of the conductor and a second section of the input.

In at least some implementations, a transmitter is received in the interior, wherein an electrical circuit includes the home contact, the conductor, the first contact, and the transmitter and the electrical circuit is complete when the conductor is in the first actuating position and the electrical circuit is not complete when the conductor is in the home position.

In at least some implementations, the body includes a base and a cover and the input is positioned on one or both of the base and the cover.

In at least some implementations, a biasing member yieldably biases the conductor to the home position.

In at least some implementations, the input is yieldably biased in the first direction towards the retracted position so that, absent a force that overcomes the biasing force on the input, the input is provided in the retracted position.

In at least some implementations, the input at least partially extends through an opening in the body and covers the opening from an exterior of the body.

In at least some implementations, a vehicle access device includes a body having an interior, an input carried by the body, a conductor received within the interior, a home contact received within the interior, a first contact received within the interior, a second contact received within the interior. The conductor, the home contact, the first contact, and the second contact are capable of conducting electricity, the input is accessible from outside the body, the input is movable in a first direction from a retracted position to an advanced position, and the input is movable in a second direction, perpendicular to the first direction, between a home position, a first actuating position, and a second actuating position. The conductor is selectively movable with the input in the second direction between the home position, the first actuating position, and the second actuating position, wherein in the home position, the conductor is in contact with the home contact but not the first contact or the second contact, in the first actuating position the conductor is in contact with both the home contact and the first contact, and in the second actuating position the conductor is in contact with both the home contact and the second contact.

In at least some implementations, the input is movable in the first direction relative to the conductor and when the input is in the advanced position, the conductor is movable with the input in the second direction, and when the input is in the retracted position, the input is movable in the second direction independently from the conductor.

In at least some implementations, the input is releasably engageable with the conductor through contact between an input coupling portion of the conductor and a second section of the input.

In at least some implementations, a transmitter is received in the interior, wherein an electrical circuit includes the home contact, the conductor, the first contact, and the transmitter and the electrical circuit is complete when the conductor is in the first actuating position and the electrical circuit is not complete when the conductor is in the home position.

In at least some implementations, a transmitter is received in the interior, wherein an electrical circuit includes the home contact, the conductor, the second contact, and the transmitter and the electrical circuit is complete when the conductor is in the second actuating position and the electrical circuit is not complete when the conductor is in the home position.

In at least some implementations, a biasing member yieldably biases the conductor to the home position.

In at least some implementations, the input is yieldably biased in the first direction towards the retracted position so that, absent a force that overcomes the biasing force on the input, the input is provided in the retracted position.

In at least some implementations, the body includes a base and a cover and the input is positioned on one or both of the base and the cover.

In at least some implementations, the input at least partially extends through an opening in the body and covers the opening from an exterior of the body.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 shows a vehicle access device with an input in a home position;

FIG. 2 shows the vehicle access device of FIG. 1 with the input in a first actuating position;

FIG. 3 shows the vehicle access device of FIG. 1 with the input in a second actuating position;

FIG. 4 shows a cross-section of the vehicle access device of FIG. 1 with the input and a conductor in the home position;

FIG. 5 shows a cross-section of the vehicle access device of FIG. 1 with the input in the first actuating position and the conductor in the home position;

FIG. 6 shows a cross-section of the vehicle access device of FIG. 1 with the input in the second actuating position and the conductor in the home position;

FIG. 7 shows a cross-section of the vehicle access device of FIG. 1 with the input and the conductor in the first actuating position;

FIG. 8 shows a cross-section of the vehicle access device of FIG. 1 with the input and the conductor in the second actuating position;

FIG. 9 shows a vehicle access device with an input in a home position;

FIG. 10 shows the vehicle access device of FIG. 9 with the input in a first actuating position;

FIG. 11 shows a cross-section of the vehicle access device of FIG. 9 with the input and the conductor in the home position;

FIG. 12 shows a cross-section of the vehicle access device of FIG. 9 with the input in the first actuating position and the conductor in the home position; and

FIG. 13 shows a cross-section of the vehicle access device of FIG. 9 with the input and the conductor in the first actuating position.

### DETAILED DESCRIPTION

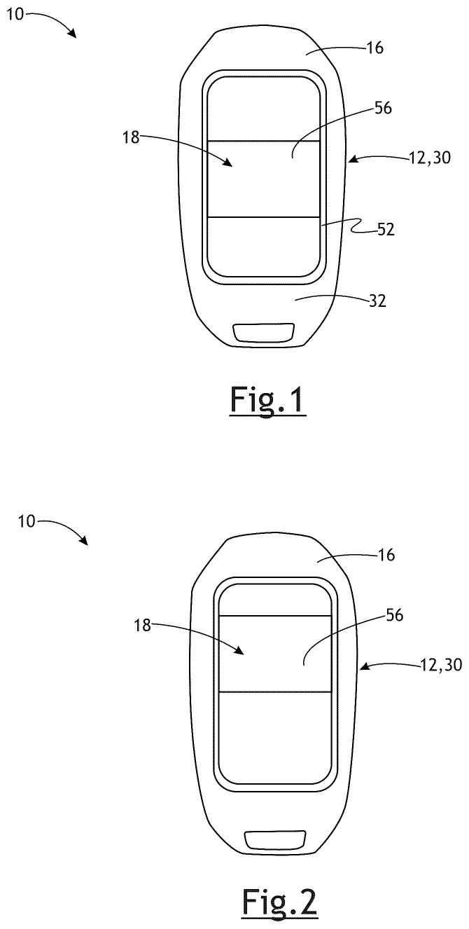

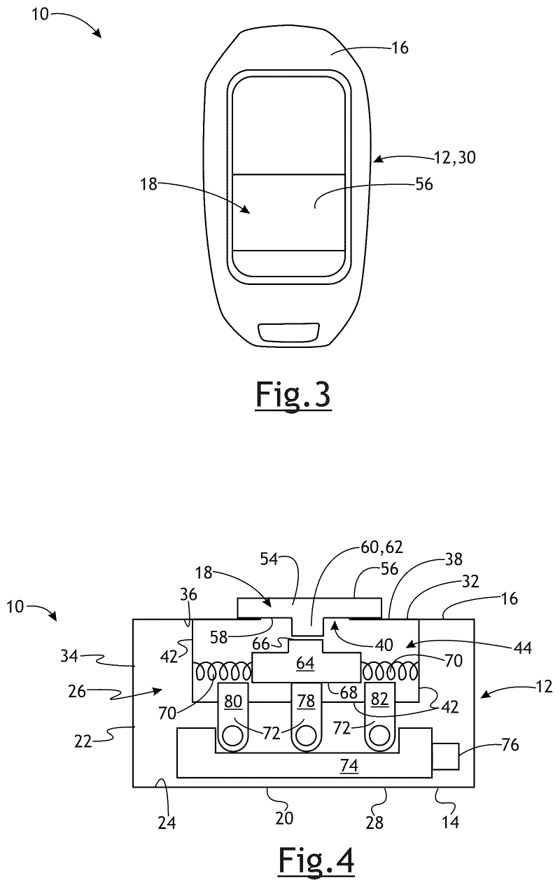

Referring in more detail to the drawings, a vehicle access device 10 may provide a user access to a vehicle and control vehicle functions such as, but not limited to the position of door locks (e.g. locked or unlocked), the position of windows (e.g. opened or closed), an alarm of the vehicle, among others. The vehicle access device 10 may be a “key fob” and has a body 12 with a base 14, a cover 16 attached to the base 14 and one or more inputs 18 that are actuated by a user to cause an output signal to be emitted from the key fob 10 to control a vehicle function. In the implementation shown in FIGS. 1-3, the body 12 is generally rectangular in shape with curved edges, however, other shapes are possible depending on the desired configuration.

The base 14 of the vehicle access device has a bottom wall 20 and side walls 22 coupled to and extending away from the bottom wall 20 to an open top. The base 14 has an inner surface 24 that spans an inner side of the bottom wall 20 and the side walls 22 and defines an interior of the base 14 and part of an interior 26 of the vehicle access device 10. An outer surface of the bottom wall 20 and the base side walls 22 collectively define an exterior 28 of the base 14 and part of an exterior 30 of the vehicle access device 10. An upper portion of the base side walls 22 may be configured to releasably couple to the cover 16.

In at least some implementations, the cover 16 has a top wall 32 and side walls 34 extending away from the top wall 32 to a free end defining an open end of the cover. An inner surface 36 of the cover 16 defines part of the interior 26 of the vehicle access device 10. An outer surface 38 of the cover 16 defines part of the exterior 30 of the vehicle access device 10. The cover 16 may have an opening 40 extending that is configured to receive the input 18. The opening 40 may extend from the exterior 30 of the vehicle access device 10 through the top wall 32 of the cover 16 and into the interior 26, however, the opening 40 may be positioned through any portion of the exterior 30 of the vehicle access device 10. The cover side walls 34 may be generally aligned with and configured to be releasably coupled to the base side walls 22, such as by snap-fit connection features, interference fit, or by connectors, such as screws, clips or the like.

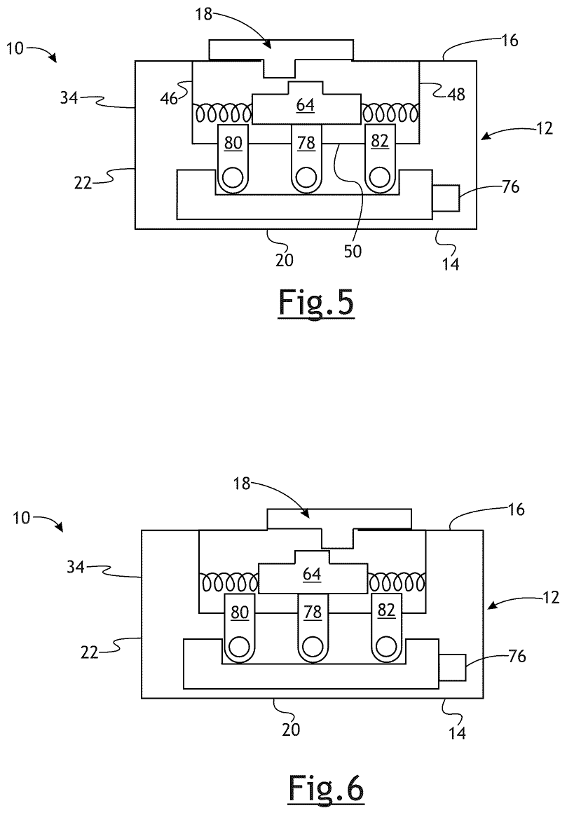

The outer surfaces 28, 38 of the base and cover 14 define the exterior 30 of the body 12 of the vehicle access device 10, and the interior 26 is defined between the inner surfaces 24, 36 of the base 14 and the cover 16. In at least some implementations, one or more interior walls 42 may be provided in the interior 26 to form one or more separate compartments within the interior 26. For example, as shown in FIG. 5, a switch compartment 44 may be defined by a first interior side wall 46 and second interior side wall 48 that extend from the cover 16 into the interior 26 and an interior bottom wall 50 that extends from the interior side walls 46, 48 generally parallel to both the base 14 and the cover 16.

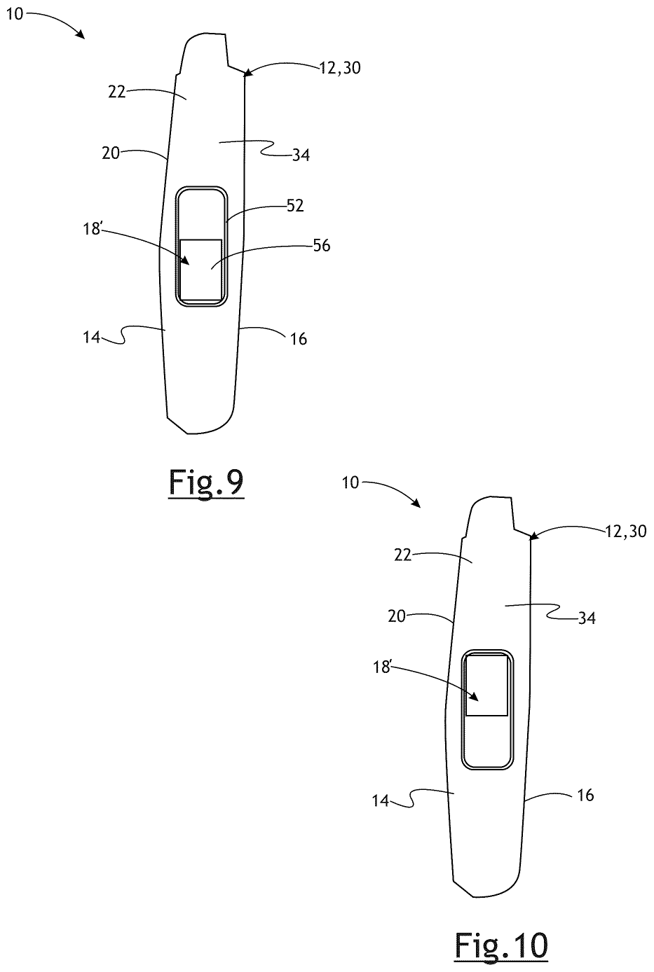

The opening 40 may extend into the switch compartment 44 of the interior 26. For example, in FIGS. 1-8 the opening 40 is positioned through the cover 16, and in FIGS. 9-13 the opening 40 is located in one or both of the cover side wall 34 or the base side wall 22. In some implementations, the cover 16 may have a clear or translucent portion 52 (FIGS. 1-3 and 9-10) permitting illumination of at least a portion of the base 14 or cover 16 using a light (e.g. a LED) positioned in the interior 26 of the vehicle access device 10. The translucent portion 52 of the base 14 or the cover 16 may correspond to a particular vehicle function to be initiated by the vehicle access device 10.

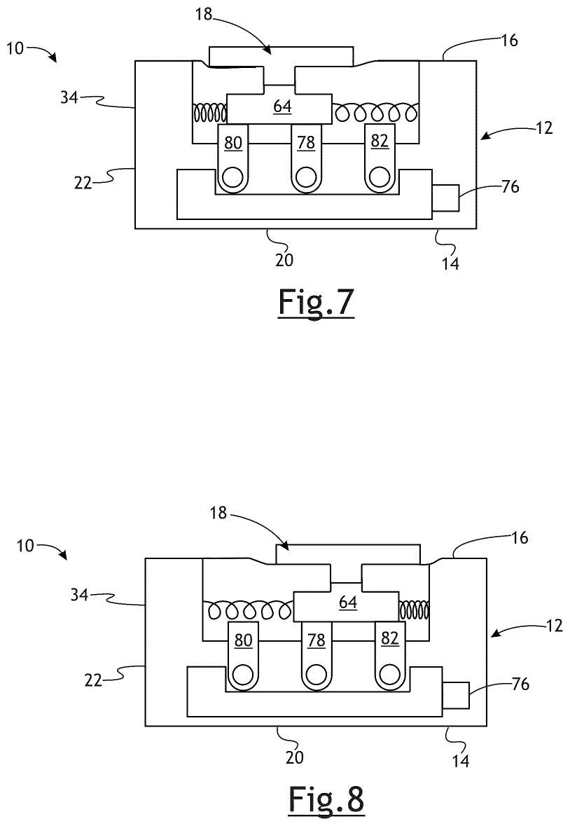

The input 18 has a first section 54 positioned outboard of or accessible from the exterior 30 of the vehicle access device 10. The first section 54 spans the opening 40 and has an upper surface 56 engageable by a user and a lower surface 58 opposite to the upper surface 56 that is adjacent to the cover 16. A second section 60 of the input 18 is cantilevered from the lower surface 58 of the first section 54 and has a free end 62 that extends at least partially into the opening 40 and is received within the interior 26 of the vehicle access device 10. So that the input 18 at least partially extends through the opening 40 in the body 12 and covers the opening 40 from the exterior 30 of the body 12. The input 18 may be mounted to the vehicle access device 10 for movement of the input 18 in a first, inward direction between a retracted position (shown in FIG. 4) and an advanced position (shown in FIGS. 7 and 8). In the example shown in FIGS. 1-8, when the input 18 is moved from the retracted position toward the advanced position, the free end 62 of the second section 60 moves towards the bottom wall 20 of the base 14. In at least some implementations, the input 18 may be biased to the retracted position, possibly by the resiliency of the cover material and/or by a biasing member like a spring. In this way, without an inward force applied to the input 18, the input 18 remains in the retracted position. When pressed inwardly, the input 18 is selectively engaged with a conductor 64 located within the interior 26 of the vehicle access device 10.

The conductor 64 is made of an electrically conductive material and is positioned within the switch compartment 44 of the interior 26 of the body 12. With reference to FIG. 4, the conductor 64 has an input coupling portion 66 that is selectively engaged by the second section 60 of the input 18 when the input 18 is in the advanced position. Opposite to the input coupling portion 66, the conductor 64 has an engaging surface 68, and the conductor 64 is mounted for slidable movement in a second, longitudinal direction that is perpendicular to the inward direction. In FIG. 4, the first direction (which may include the inward direction and corresponding/opposite outward direction) is shown by arrow 67, and the second direction (which may include two opposed directions) is shown by arrow 69. One or more biasing members 70, such as springs, may be positioned between interior side walls 46, 48 of the switch compartment 44 to yieldably bias the conductor 64 to a home position. As set forth later herein, the conductor 64 can be moved away from the home position to one or more actuating positions in which the conductor 64 engages two contacts 72 to complete an electrical circuit.

Two or more contacts 72 made of metal or other electrically conductive materials are positioned spaced apart within the switch compartment 44. When two of the contacts 72 are electrically engaged by the conductor 64, an electrical circuit may be completed, permitting the flow of electricity from one contact 72 through the conductor 64 to the other contact 72. The contacts 72 may extend within the interior 26 and are configured to be in electrical communication with and may be mounted on a circuit board 74 received within the interior 26 of the vehicle access device 10. In some implementations, the contacts 72 may extend through the interior side walls 46, 48 or the interior bottom wall 50 of the switch compartment 44 into the circuit board 74, which may be positioned beneath the interior bottom wall 50.

The circuit board 74 may have a base made from an insulating material such as fiberglass-reinforced epoxy resin, polyimide, or other materials that provide electrical insulation. Conductive traces or wires, made from a conductive material such as copper, are provided on the base to allow the flow of electrical signals through the circuit board 74 to components in electrical communication with the circuit board 74. For example, each conductive pathway may electrically connect a contact to a component of the vehicle access device 10 to provide power to the component, which in some implementations, may be a transmitter 76.

The transmitter 76 may be mounted within the interior 26 of the vehicle access device 10 and may be powered by a battery to send signals to a vehicle control system to control one or more functions of the vehicle. Signals from the vehicle access device transmitter 76 can be any form of wireless communication such as, but not limited to short-range or long-range communications, such as cellular, ultra-wideband (UWB), near-field communications, Bluetooth, WiFi, satellite communications, radio, or others. The vehicle, may be configured to receive signals from the vehicle access device and control, via a vehicle control system, one or more vehicle functions based on signals received from the vehicle access device 10.

An embodiment of a vehicle access device 10 having an input 18 that is movable between three positions, and with three contacts 78, 80, 82 in electrical communication with the circuit board 74 is shown by FIGS. 1-8. In FIGS. 1 and 4, the input 18 is shown in the home position in which the input 18 is generally centered in the opening 40 relative to the cover 16, and the input 18 is not engaged with the conductor 64. The conductor 64 is electrically engaged with only a center, home contact 78 of the three contacts and in this position, no electrical circuit is completed by the conductor 64. Without inward pressure applied by the user to the input 18, the input 18 remains in the retracted position and can be slidably moved from the home position (FIG. 4) in the longitudinal direction and independently from the conductor 64 to a first actuating position (FIG. 5) and a second actuating position (FIG. 6). Thus, without engagement between the input 18 and the conductor 64, the conductor 64 remains in the home position even when the input is moved in the second or longitudinal direction. In at least some implementations, the input 18 and conductor 64 are biased to the home position so that absent any force applied by the user, the input 18 is in the home position and the conductor 64 is in contact with only the home contact 78.

When the input 18 is in the home position and inward pressure is applied by the user to the input 18, the input 18 is moved to the advanced position and second section 60 of the input 18 engages the input coupling portion 66 of the conductor 64. Once engaged, and while the input 18 remains pressed inwardly, the input 18 and conductor 64 can move together in the second direction as dictated by the user to or between the first actuating position (FIG. 7) and the second actuating position (FIG. 8).

In at least some implementations, the first and second actuating positions may be defined by engagement of the input with the cover at the opposite ends of the opening. That is, movement of the input in the second direction might be limited by the cover in one or both directions. So, the size of the opening is a function of the movement needed by the input. When the input 18 and conductor 64 are in the first actuating position, as shown in FIG. 7, the conductor 46 contacts both the home contact 78 and a first contact 80. When the conductor 64 contacts both the home contact 78 and the first contact 80, a first circuit is complete and power or a signal is provided to the transmitter 76. When the transmitter 76 receives power through the first circuit, the transmitter 76 is configured to transmit a first signal to the vehicle corresponding to a first vehicle function. Upon receiving the first signal, the vehicle, possibly through a vehicle control system, activates the first vehicle function. The first vehicle function may include controlling door locks, opening/closing doors, opening/closing windows, controlling vehicle ignition, controlling vehicle horn, controlling vehicle lights, controlling vehicle alarm system, among others. Upon release of the input 18 by the user, the input 18 and the conductor 64 are returned to the home position by the biasing members 70 and the biasing force of the cover or other biasing member acting on the input. This terminates electrical communication through the second circuit.

When the input 18 and conductor 64 are in the second actuating position, as shown in FIG. 8, the conductor 64 contacts both the home contact 78 and a second contact 82, but does not contact the first contact 80. When the conductor 64 contacts both the home contact 78 and the second contact 82, a second circuit is complete and power or a signal is provided to the transmitter 76. When the transmitter 76 receives power through the second circuit, the transmitter 76 is configured to transmit a second signal to the vehicle corresponding to a second vehicle function. Upon receiving the second signal, the vehicle, possibly through the vehicle control system, activates the second vehicle function. The second vehicle function may be different than the first vehicle function and may include controlling door locks, opening/closing doors, opening/closing windows, controlling vehicle ignition, controlling vehicle horn, controlling vehicle lights, controlling vehicle alarm system, among others. Upon release of the input 18 by the user, the input 18 and the conductor 64 are returned to the home position by the biasing members 70 and the biasing force of the cover or other biasing member acting on the input. This terminates electrical communication through the second circuit.

An embodiment of a vehicle access device 10 having an 18′ input that is operable in two positions is shown by FIGS. 9-13. As shown in FIGS. 9 and 10, the input 18′ may be located on a side of the vehicle access device 10 in one or both of the base side wall 22 and the cover side wall 34. However, the input 18′ may be located in other positions on the vehicle access device 10 as desired, including on the cover 16 as described with regard to the embodiment of FIGS. 1-8.

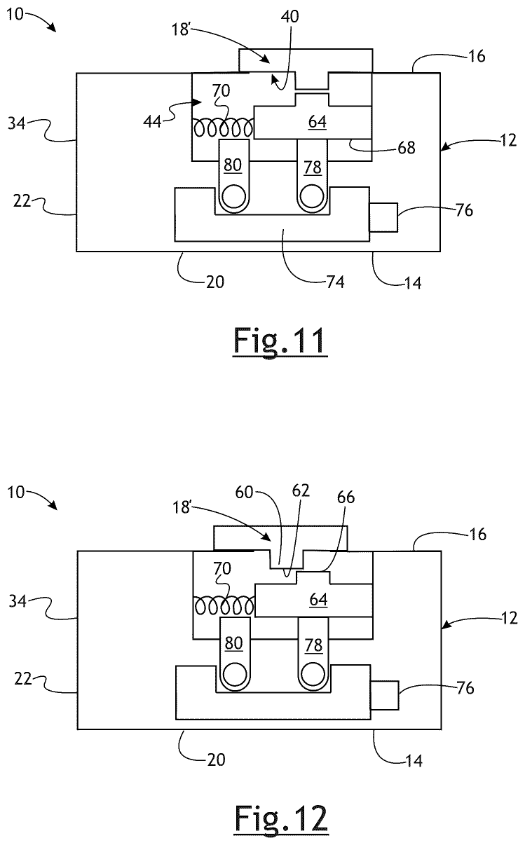

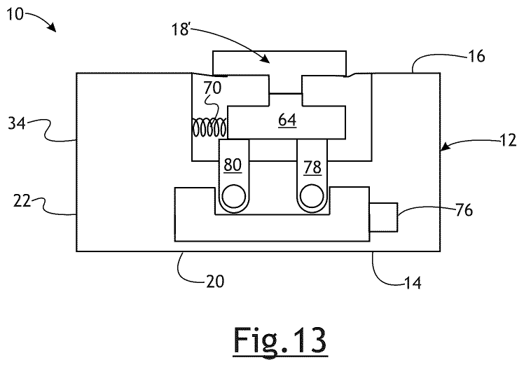

As shown in FIGS. 9 and 11, the input 18′ is normally in (e.g. biased to) a home position and can be moved to the first actuating position (FIGS. 10 and 13) by a user of the vehicle access device 10. However, if the input 18′ is moved longitudinally, without first being moved inwardly, the input 18 remains in the retracted position and can move independently from the conductor, as shown in FIG. 12. That is, without engagement between the input coupling portion 66 of the conductor 64 and the second section 60 of the input 18′, the conductor 64 remains in the home position. In this position, the conductor 64 touches the home contact 78 but not a first contact 80 and so an electrical circuit associated with the conductor 64 and the first contact 80 is open or not completed. Therefore, in the home position, electrical power is not provided through the circuit board 74 to the transmitter 76 and a signal is not sent by the transmitter 76.

To achieve the first actuating position shown in FIG. 13, the input 18′ is moved inwardly to the advanced position in which the input 18′ engages the conductor 64, and then the input 18′ and conductor 64 are moved together in the second direction so that the conductor 64 contacts both the home contact 78 and the first contact 80. When the conductor 64 contacts both the home contact 78 and the first contact 80, the electrical circuit is complete and the transmitter 76 is caused to transmit a corresponding signal. Upon release of the input 18′ by the user, the input 18′ and the conductor 64 are returned to the home position by the biasing forces acting thereon, and this terminates electrical communication through the electrical circuit.

Key fobs may use push-activated buttons or touch screens to activate vehicle functions. However, these buttons or touch screens may be accidentally activated by inadvertent contact with a user or another item in handling the key fob. For example, buttons or touch screens may be activated by pressure applied inadvertently by the user, or by a user's clothing when the key fob is placed within a pocket of the user's clothing or by a neighboring item when the key fob is placed in a bag or amongst other items. This results in unintended transmission from the key fob and the unintended activation of one or more vehicle functions. For example, a vehicle may be accidentally unlocked or the ignition may be remotely started or a liftgate or other door may be opened by inadvertent activation of a button or a touch screen, potentially leaving the vehicle unsecured.

By requiring the input 18, 18′ of the vehicle access device 10 to be moved in a first direction to the advanced position before the input 18, 18′ is engaged by the conductor 64, and then requiring longitudinal sliding movement of the input 18, 18′ in a second direction while it remains pressed inwardly, the vehicle access device 10 disclosed herein can prevent accidental actuation of the input(s) 18, 18′ and accidental transmission of signals from the vehicle access device 10. Pressing the input 18, 18′ without also longitudinally sliding the input 18, 18′ while the input 18, 18′ is pressed inwardly, or sliding the input 18, 18′ longitudinally without first pressing the input 18, 18′ inwardly, will not result in transmission of a signal from the vehicle access device 10.

While the input 18, 18′ is described as moving in the first direction relative to the conductor 64, and the conductor 64 is described as moving only in the second direction when driven by the input 18, 18′, the conductor 64 could be connected to the input 18, 18′ so that the conductor 64 moves with the input 18, 18′ in the first direction and relative to the contacts 72. In such an arrangement, the conductor 64 would not touch any of the contacts 72 when the input 18, 18′ is in the home position, and the conductor 64 would only engage the contacts 72 when the input 18, 18′ was pressed sufficiently inwardly (e.g. to the advanced position, in the first direction. And the conductor 64 would only engage two of the contacts 72 when the input was both pressed inwardly to the advanced position and also moved in the second direction, as described herein. Still other modifications can be made that are within the scope of this disclosure.

What is claimed is:

1. A vehicle access device comprising:
a body having an interior;
an input carried by the body;
a conductor received within the interior;
a home contact received within the interior; and
a first contact received within the interior, wherein the conductor, the home contact, and the first contact are capable of conducting electricity, the input is accessible from outside the body, the input is movable in a first direction from a retracted position to an advanced position, and the input is movable in a second direction, perpendicular to the first direction, between a home position and a first actuating position, and the conductor is selectively movable with the input in the second direction between the home position and the first actuating position, wherein in the home position, the conductor is in contact with the home contact but not the first contact, and in the first actuating position the conductor is in contact with both the home contact and the first contact.

2. The vehicle access device of claim 1, wherein the input is movable in the first direction relative to the conductor and when the input is in the advanced position, the conductor is movable with the input in the second direction, and when the input is in the retracted position, the input is movable in the second direction independently from the conductor.

3. The vehicle access device of claim 2, wherein the input is releasably engageable with the conductor through contact between an input coupling portion of the conductor and a second section of the input.

4. The vehicle access device of claim 1, further comprising a transmitter received in the interior, wherein an electrical circuit includes the home contact, the conductor, the first contact, and the transmitter and the electrical circuit is complete when the conductor is in the first actuating position and the electrical circuit is not complete when the conductor is in the home position.

5. The vehicle access device of claim 1, wherein the body includes a base and a cover and the input is positioned on one or both of the base and the cover.

6. The vehicle access device of claim 1, further comprising a biasing member that yieldably biases the conductor to the home position.

7. The vehicle access device of claim 1, wherein the input is yieldably biased in the first direction towards the retracted position so that, absent a force that overcomes the biasing force on the input, the input is provided in the retracted position.

8. The vehicle access device of claim 1, wherein the input at least partially extends through an opening in the body and covers the opening from an exterior of the body.

9. A vehicle access device comprising:
a body having an interior;
an input carried by the body;
a conductor received within the interior;
a home contact received within the interior;
a first contact received within the interior;
a second contact received within the interior, wherein the conductor, the home contact, the first contact, and the second contact are capable of conducting electricity, the input is accessible from outside the body, the input is movable in a first direction from a retracted position to an advanced position, and the input is movable in a second direction, perpendicular to the first direction, between a home position, a first actuating position, and a second actuating position, and the conductor is selectively movable with the input in the second direction between the home position, the first actuating position, and the second actuating position, wherein in the home position, the conductor is in contact with the home contact but not the first contact or the second contact, in the first actuating position the conductor is in contact with both the home contact and the first contact, and in the second actuating position the conductor is in contact with both the home contact and the second contact.

10. The vehicle access device of claim 9, wherein the input is movable in the first direction relative to the conductor and when the input is in the advanced position, the conductor is movable with the input in the second direction, and when the input is in the retracted position, the input is movable in the second direction independently from the conductor.

11. The vehicle access device of claim 10, wherein the input is releasably engageable with the conductor through contact between an input coupling portion of the conductor and a second section of the input.

12. The vehicle access device of claim 9, further comprising a transmitter received in the interior, wherein an electrical circuit includes the home contact, the conductor, the first contact, and the transmitter and the electrical circuit is complete when the conductor is in the first actuating position and the electrical circuit is not complete when the conductor is in the home position.

13. The vehicle access device of claim 9, further comprising a transmitter received in the interior, wherein an electrical circuit includes the home contact, the conductor, the second contact, and the transmitter and the electrical circuit is complete when the conductor is in the second actuating position and the electrical circuit is not complete when the conductor is in the home position.

14. The vehicle access device of claim 9, further comprising a biasing member that yieldably biases the conductor to the home position.

15. The vehicle access device of claim 9, wherein the input is yieldably biased in the first direction towards the retracted position so that, absent a force that overcomes the biasing force on the input, the input is provided in the retracted position.

16. The vehicle access device of claim 9, wherein the body includes a base and a cover and the input is positioned on one or both of the base and the cover.

17. The vehicle access device of claim 9, wherein the input at least partially extends through an opening in the body and covers the opening from an exterior of the body.
